(19) United States
(12) Patent Application Publication
(10) Pub. No.: US 2009/0178643 A1
(43) Pub. Date: Jul. 16, 2009

(54) METHOD FOR COMBUSTING FUEL

(76) Inventor: Philipp ROGLER, Stuttgart (DE)

Correspondence Address: KENYON & KENYON LLP, ONE BROADWAY, NEW YORK, NY, 10004, US

(21) Appl. No.: 12/326,437

(22) Filed: Dec. 2, 2008

(30) Foreign Application Priority Data
Jan. 10, 2008 (DE) 102008003842.3

(51) Int. Cl. F02B 5/00

(52) U.S. Cl. 123/305

(57) ABSTRACT

A method for combusting fuel in a combustion chamber of an internal combustion engine, in which air is supplied to the combustion chamber via at least one intake valve and at least one fanned-out fuel spray is injected into the combustion chamber via at least one fuel injector in such a way that at least one layer charge cloud composed of a fuel/air mixture is produced and the layer charge cloud is ignited using at least one ignition device. For achieving a higher degree of efficiency during combustion, the at least one layer charge cloud is ignited in the combustion chamber at at least two spatially separated ignition points, the ignition being carried out simultaneously or staggered in time.

### FIELD OF THE INVENTION

The present invention is directed to a method for combusting fuel in a combustion chamber of an internal combustion engine.

### BACKGROUND INFORMATION

A known fuel injection system (German Patent Application No. DE 100 32 336) has a fuel injector, which injects fuel directly into a combustion chamber delimited by a cylinder wall and a piston guided therein, and a spark plug protruding into the combustion chamber. The fuel injector produces a cone-shaped injection spray in the combustion chamber through at least one row of injection orifices which are situated around the circumference of a valve body. A centrally located injection orifice is additionally provided in the valve body which produces a fuel-enriched central area of the injection spray which reaches the spark plug. This forms a mixture cloud in the combustion chamber which has a stoichiometric or slightly rich core (0.8<λ<1.1) and a lean envelope (1.5<λ). If the core of the mixture cloud moves in the area of the spark plug spark path at the moment of ignition, then the core is able to quickly ignite, combust, and on its part ignite the lean envelope. This combustion process is characterized in that the internal combustion engine may be operated dethrottled in the partial load operation. This makes it possible to significantly reduce the throttle losses compared to conventional operation with external mixture formation, which results in potential fuel savings. The high nitrogen oxide emissions caused by the combustion of the lean envelope present challenges. This may be countered by reducing the combustion temperatures, which is implementable by increasing the internal or, better yet, the external exhaust gas recirculation rate. However, by increasing the exhaust gas recirculation rate, the propagation speed of the flame is reduced, which in turn lowers the combustion efficiency.

### SUMMARY OF THE INVENTION

The method according to the present invention for combusting fuel in a combustion chamber of an internal combustion engine has the advantage that by igniting the at least one layer charge cloud at different locations within the combustion chamber, the mixture cloud combusts more rapidly at the same combustion rate at a higher maximum pressure. This enables combustion with higher efficiency whereby the fuel consumption may be lowered. The raw emissions may be lowered by the ignition taking place at instants at which the mixture homogeneity is established and the mean air/fuel ratio changes only a little due to faster combustion and a better burnout takes place.

Ignition at the ignition points may be carried out simultaneously or also staggered in time. In the former case, a rapid fuel conversion is achieved at a high pressure rise, thereby increasing the combustion efficiency. In the latter case, a retardation of the combustion takes place in contrast to the former case, having the advantage of noise reduction and lower component stress. Overall, the desired pressure curve may be formed by multiple ignitions at different points in time, whereby a burnout may be achieved as rapidly as possible at as many as possible ignition points. By shaping the pressure curve, the chronological sequence of fuel conversion and noise may be controlled. The ignition points may be situated symmetrically or asymmetrically in the combustion chamber. Knocking may be avoided if the ignition points are situated in regions that are prone to knocking, e.g., close to the hot exhaust valves.

### BRIEF DESCRIPTION OF THE DRAWINGS

FIG. 1 shows in detail a longitudinal section of a combustion cylinder of an internal combustion engine having an injection system according to a first exemplary embodiment.

FIG. 2 shows in detail a longitudinal section of a combustion cylinder of an internal combustion engine having an injection system according to a second exemplary embodiment.

### DETAILED DESCRIPTION

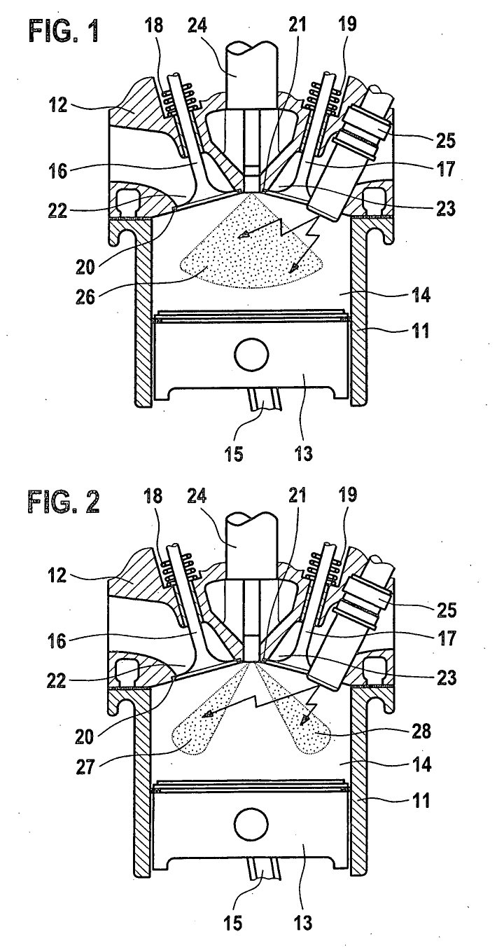

The combustion cylinder shown in detail in a longitudinal section in FIGS. 1 and 2 has a cylinder cavity 11 and a cylinder head 12 covering cylinder cavity 11. A piston 13, which, together with cylinder head 12 in cylinder cavity 11 encloses a combustion chamber 14, is axially movably guided in cylinder cavity 11. Piston 13 is connected to a crankshaft (not shown) of an internal combustion engine in a known manner via a connecting rod 15. An intake valve 16 and an exhaust valve 17 are situated in cylinder head 12 and rest under the effect of valve closing springs 18 and 19, with a valve disk, on a valve seat 20, 21 formed in cylinder head 12 and which are lifted from valve seats 20 and 21 with the aid of a valve operating mechanism (not shown here). Valve seat 20 encloses a combustion chamber inlet 22 for supplying combustion air, and valve seat 21 encloses a combustion chamber outlet 23 for discharging the combusted exhaust gases.

Furthermore, a fuel injector 24 for injecting atomized fuel into combustion chamber 14 and an ignition device 25 are situated in cylinder head 12. Fuel injector 24, used in FIG. 1, is designed in such a way that it injects the fuel in the form of a fanned-out fuel spray which forms, together with the air quantity flowing in via intake valve 16, a layer charge cloud 26. Ignition device 25 is designed in such a way that it triggers ignition of layer charge cloud 26 in combustion chamber 14 at two spatially separated ignition points. This is symbolized in FIG. 1 by two flash arrows illustrating an ignition spark.

Layer charge cloud 26 may be ignited simultaneously or staggered in time. Ignition device 25 may be implemented using one spark plug, which has multiple ignition points, or using multiple spark plugs. An ignition system made up of at least one laser-based ignition device, which generates a total of at least two ignition foci, is usable.

The exemplary embodiment shown in FIG. 2 differs from the above-explained exemplary embodiment in FIG. 1 only in that fuel injector 24 is designed in such a way that it injects at least two separated fanned-out fuel sprays into combustion chamber 14 which, together with the combustion air flowing in via intake valve 16, generate at least two separate layer charge clouds 27, 28. The ignition points of ignition device 25 for igniting layer charge clouds 27, 28 are each placed into the separated layer charge clouds 27, 28, as is indicated in FIG. 2 by the flash arrows symbolizing the ignition sparks. Fuel injectors which inject separate fuel sprays into combustion chamber 14 are known. Such a fuel injector may be designed like the injector described in German Patent Application No. DE 100 26 321, if another angular section is left without fuel in the cone-shaped injection spray.

What is claimed is:

1. A method for combusting fuel in a combustion chamber of an internal combustion engine, comprising:
supplying air to the combustion chamber via at least one intake valve;
injecting at least one fanned-out fuel spray into the combustion chamber with the aid of at least one fuel injector in such a way that at least one layer charge cloud composed of a fuel/air mixture is produced; and
igniting the at least one layer charge cloud in the combustion chamber at at least two spatially separated ignition points using at least one ignition device.

2. The method according to claim 1, wherein the ignition is carried out simultaneously at the at least two ignition points.

3. The method according to claim 1, wherein the ignition is carried out temporally staggered at the at least two ignition points.

4. The method according to claim 1, wherein a plurality of layer charge clouds are produced in the combustion chamber and in each case at least one ignition point is placed into one of the layer charge clouds.
